(19) United States
(12) Patent Application Publication
(10) Pub. No.: US 2018/0135734 A1
(43) Pub. Date: May 17, 2018

(54) Electromagnetic Device For Ball-Type Continuously Variable Transmission

(71) Applicant: Dana Limited, Maumee, OH (US)

(72) Inventor: Joseph J. Horak, Austin, TX (US)

(21) Appl. No.: 15/857,828

(22) Filed: Dec. 29, 2017

Related U.S. Application Data
(60) Provisional application No. 62/554,178, filed on Sep. 5, 2017.

(51) Int. Cl. F16H 15/28; F16H 15/50; F16H 15/40; F16H 59/70; F16H 37/02; F16H 3/56

(52) U.S. Cl. CPC F16H 15/28; F16H 15/503; F16H 15/40; F16H 25/2204; F16H 37/022; F16H 3/56; F16H 59/70

(57) ABSTRACT

Provided herein is a sun assembly for a continuously variable transmission having a plurality of balls, each having a tiltable axis of rotation, a first traction ring assembly in contact with each ball, a second traction ring assembly in contact with each ball, the sun assembly having a first sun ring and a second sun ring located radially inward of, and in contact with, each ball. The sun assembly is operably coupled to an electromagnetic device. In some embodiments, the electromagnetic device is a bearing configured to provide radial support to the balls. In some embodiments, the electromagnetic device is a motor configured to produce an output power from the sun assembly. In some embodiments the electromagnetic device is a speed sensor. In some embodiments, the electromagnetic device is a selectable torque transmitting device.

### RELATED APPLICATION

This application claims the benefit of U.S. Provisional Patent Application No. 62/554,178, filed Sep. 5, 2017, which is incorporated herein by reference in its entirety.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY

Provided herein is a sun assembly for a continuously variable transmission having a plurality of balls, each having a tiltable axis of rotation, a first traction ring assembly in contact with each ball, a second traction ring assembly in contact with each ball, the sun assembly including: a first sun ring; a second sun ring; wherein the first sun ring and the second sun ring are located radially inward of, and coupled to, each ball; a sun support member located radially inward of, and coupled to, the first sun ring and the second sun ring; and an electromagnetic device operable coupled to the sun support member.

Provided herein is a continuously variable transmission (CVT) having a plurality of balls, each having a tiltable axis of rotation, a first traction ring assembly in contact with each ball, a second traction ring assembly in contact with each ball, the CVT including: a carrier assembly configured to support each tiltable axis of rotation; a sun assembly in contact with each ball, the sun assembly comprising: a first sun ring; a second sun ring; wherein the first sun ring and the second sun ring are located radially inward of, and coupled to, each ball; a sun support member located radially inward of, and coupled to, the first sun ring and the second sun ring; and an electromagnetic device operable coupled to the sun support member and the carrier assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present embodiments will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that can be used in the variator of FIG. 1.

FIG. 3 is an illustrative view of different tilt positions of the ball-type variator of FIG. 1.

FIG. 4 is a partial cross-section view of a ball-type variator having a sun assembly.

FIG. 5 is a schematic diagram of an electromagnetic device integrated into the sun assembly of FIG. 4.

### DETAILED DESCRIPTION OF THE PREFERRED EMBODIMENTS

The embodiments described below relate to components that can be used in a ball planetary style continuously variable transmission, such as the Variglide®.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the embodiments can include several novel features, no single one of which is solely responsible for its desirable attributes or which is essential to practicing the inventions described.

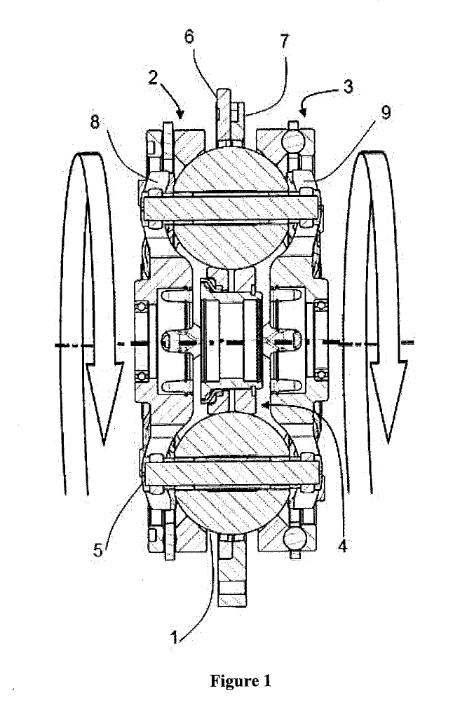

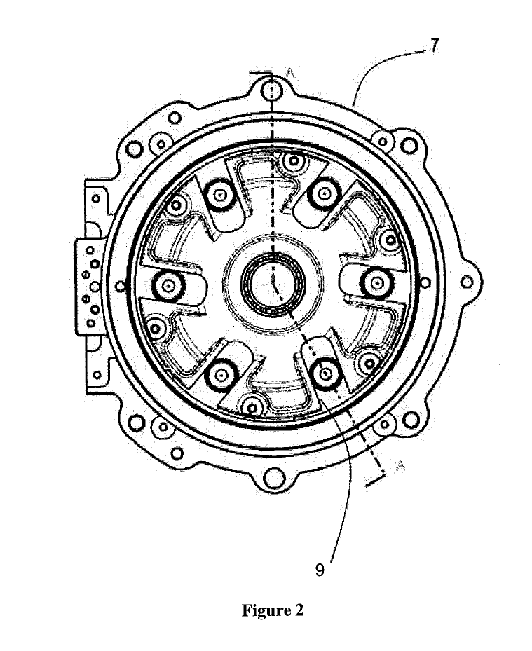

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) 2 and output (second) 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member, and vice versa. In one embodiment, the first carrier member 6 can be provided with a number of radial guide slots 8. The second carrier member 7 can be provided with a number of radially offset guide slots 9. The radial guide slots 8 and the radially offset guide slots 9 are adapted to guide the tiltable axles 5. The axles 5 can be adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

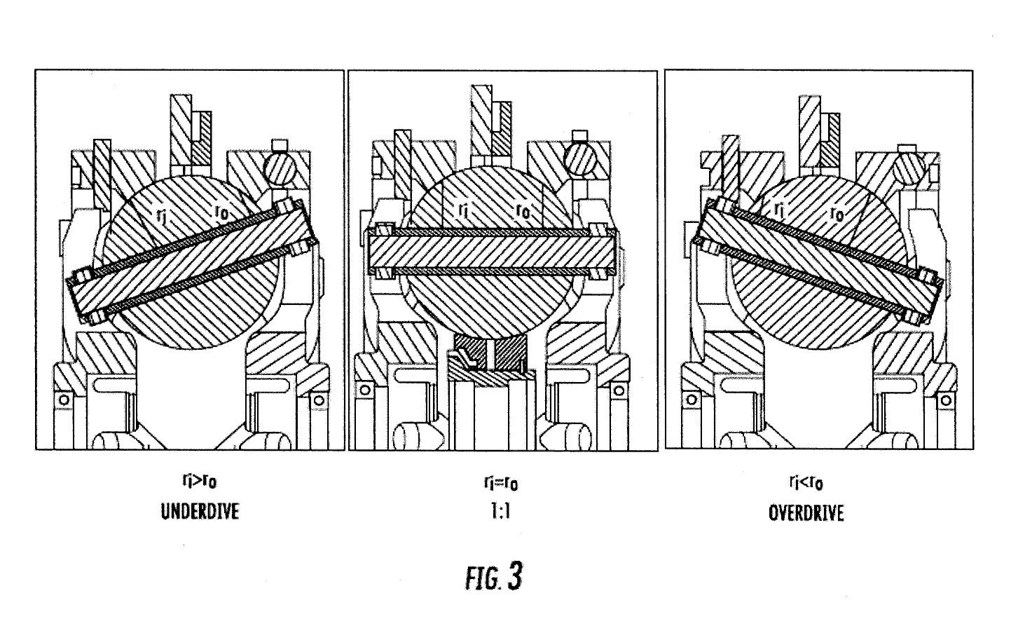

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

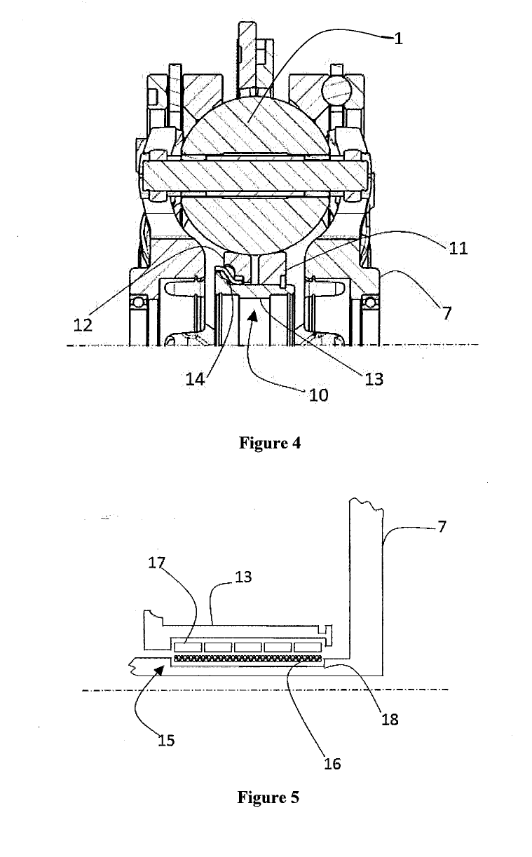

Referring now to FIG. 4, in some embodiment, a sun assembly 10 is configured to be radially inward of, and in contact with each ball 1. In some embodiments, the sun assembly 10 is substantially similar to the sun assembly 4 (FIG. 1). The sun assembly 10 provides radial support to each ball 1 during operation of the CVP. The sun assembly 10 includes first sun ring 11 and a second sun ring 12, each in contact with the ball 1. The first sun ring 11 and the second sun ring 12 are coupled to a sun support member 13. In some embodiments, the sun assembly 10 includes a bearing 14 configured to couple the second sun ring 12 to the sun support member 13. During operation of the CVP, the first sun ring 11 and the second ring 12 experience different rotational speeds proportional to the speed or torque ratio. In some embodiments, the bearing 14 is positioned between the first sun ring 11 and the sun support member 13. In other embodiments, two bearings (not shown) are provided to couple the first sun ring 11 and the second sun ring 12 to the sun support member 13.

Turning now to FIG. 5, in some embodiments, the sun support member 13 is adapted to couple to a non-rotating component of the CVP, such as the second carrier member 7, with an electromagnetic device 15. In some embodiments, the electromagnetic device 15 includes a coil layer 16 and a magnet layer 17. In some embodiments, the coil layer 16 includes a number of layers of copper wire coupled to an extension portion 18 of the second carrier member 7. It should be appreciated that the first carrier member 6 is optionally configured to couple to the electromagnetic device 15. In some embodiments, the magnet layer 17 includes a number of permanent magnets attached to the sun support member 13.

During operation of the CVP, the electromagnetic device 15 is configured as a bearing and provides radial support to the sun assembly 10. During certain operating conditions, the electromagnetic device 15 is controlled by an electronic control system (not shown) to extract an output power from the CVP. For example, the electromagnetic device 15 is optionally configured to provide radial load support to the sun support member 13 as well as electric motor functionality. In some embodiments, the electromagnetic device 15 is optionally configured as a speed sensor to provide a signal indicative of the rotational speed of the sun support member 13. In some embodiments, the electromagnetic device 15 is optionally configured as a clutch mechanism for selectively coupling the sun support member 13 to the second carrier member 7 to thereby ground the sun support member 13 from rotating.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the preferred embodiments, except in so far as any one claim makes a specified dimension, or range of thereof, a feature of the claim.

While the preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A sun assembly for a continuously variable transmission having a plurality of balls, each having a tiltable axis of rotation, a first traction ring assembly in contact with each ball, a second traction ring assembly in contact with each ball, the sun assembly comprising:
a first sun ring;
a second sun ring, wherein the first sun ring and the second sun ring are located radially inward of, and coupled to, each ball;
a sun support member located radially inward of, and coupled to, the first sun ring and the second sun ring; and
an electromagnetic device operable coupled to the sun support member.

2. The sun assembly of claim 1, wherein the electromagnetic device further comprises a coil layer and a magnet layer.

3. The sun assembly of claim 2, wherein the coil layer comprises a plurality of layers of copper wire.

4. The sun assembly of claim 3, wherein the coil layer is non-rotating.

5. The sun assembly of claim 2, wherein the magnet layer comprises a plurality of permanent magnets.

6. The sun assembly of claim 5, wherein the magnet layer is coupled to the sun support member.

7. The sun assembly of claim 1, wherein the electromagnetic device is configured to provide radial bearing support to the sun support member, the first sun ring, and the second sun ring.

8. The sun assembly of claim 1, wherein the electromagnetic device is a motor, wherein the motor provides an output power from the sun assembly.

9. The sun assembly of claim 1, wherein the electromagnetic device is a selectable torque transmitting device.

10. The sun assembly of claim 10, wherein the selectable torque transmitting device is configured to selectively ground the sun support member from rotating.

11. A continuously variable transmission (CVT) having a plurality of balls, each having a tiltable axis of rotation, a first traction ring assembly in contact with each ball, a second traction ring assembly in contact with each ball, the CVT comprising:
a carrier assembly configured to support each tiltable axis of rotation;
a sun assembly in contact with each ball, the sun assembly comprising:
a first sun ring;
a second sun ring, wherein the first sun ring and the second sun ring are located radially inward of, and coupled to, each ball;
a sun support member located radially inward of, and coupled to, the first sun ring and the second sun ring; and
an electromagnetic device operable coupled to the sun support member and the carrier assembly.

12. The CVT of claim 12, wherein the carrier assembly is non-rotatable.
